(19) United States
(12) Patent Application Publication
(10) Pub. No.: US 2024/0265043 A1
(43) Pub. Date: Aug. 8, 2024

(54) Systems and Methods for Generating a Digital Avatar that Embodies Audio, Visual and Behavioral Traits of an Individual while Providing Responses Related to the Individual's Life Story

(71) Applicant: The Ark Project LLC, Phoenix, AZ (US)

(72) Inventors: Larry Ben Lytle, Paradise Valley, AZ (US); Larry Blanton Lytle, Phoenix, AZ (US); Narendran Muraleedharan, Scottsdale, AZ (US); Bradley Hillstrom, Jr., Phoenix, AZ (US); Joshua Banko, Paradise Valley, AZ (US); John Van Dyke, Scottsdale, AZ (US); Spencer Beckwith, Mesa, AZ (US); Rajbir Johar, Phoenix, AZ (US); David Lahtinen, Phoenix, AZ (US)

(21) Appl. No.: 18/430,553

(22) Filed: Feb. 1, 2024

Related U.S. Application Data
(60) Provisional application No. 63/483,206, filed on Feb. 3, 2023.

(51) Int. Cl. G06F 16/335; G06F 16/33; G06F 16/338; G06F 40/42

(52) U.S. Cl. CPC G06F 16/335; G06F 16/3344; G06F 16/3347; G06F 16/338; G06F 40/42

(57) ABSTRACT

Systems and methods are described for enabling a user to interact with an avatar representative of a target person. The avatar is configured to virtually embody audio, visual and behavioral characteristics of the target person and respond to the user's query based on the target person's life story. The user's query is presented in the form of audio based utterances. The target person's life story is processed in order to extract contextual, syntactic and semantic features related to the target person's audio, visual and linguistic characteristics.

### CROSS-REFERENCE

The present specification relies on U.S. Provisional Patent Application No. 63/483,206, titled “Systems and Methods for Generating a Digital Avatar that Embodies Audio, Visual, and Behavioral Traits of An Individual While Providing Responses Related to the Individual's Life Story”, filed on Feb. 3, 2023, for priority, the entirety of which is herein incorporated by reference in its entirety.

### FIELD

The present specification is related generally to the field of natural language processing and digital avatars. More specifically, the present specification is related to systems and methods for enabling the use of natural language in order to interact with an avatar representative of a target person, wherein the avatar is configured to portray audio, visual, and behavioral characteristics of the target person.

### BACKGROUND

Autobiographical accounts of individuals exist in various formats such as books, movies and audio-visual recordings. These formats, however, are passive modes in that they offer a one-way communication of the life stories of individuals to inquisitive users with little or no room for a two-way interaction between the individuals (sharing their life stories) and the users. Moreover, being passive in nature, these modes lack an ability to portray the unique personality traits of the individuals while sharing their life stories.

Virtual digital assistants and avatars have been used in the realm of call centers, customer service applications, and video gaming. These digital assistants and avatars improve user experience by providing a human-like or humanoid interface that includes interactivity with an end user. However, these digital assistants and avatars still lack the flexibility, linguistic pragmatism, and personalization characteristic of human interaction.

Accordingly, there is a need for systems and methods that allow for an individual to capture, process, organize and preserve their life story. There is also a need for systems and methods to generate an alter ego or avatar representative of the individual, wherein the avatar may interact with an inquisitive user, and wherein the avatar is configured to adopt, absorb, and/or virtually embody audio, visual and behavioral traits of the individual while responding to the user's queries based on the target person's life story.

### SUMMARY

The following embodiments and aspects thereof are described and illustrated in conjunction with systems, tools and methods, which are meant to be exemplary and illustrative, and not limiting in scope. The present application discloses numerous embodiments.

In some embodiments, the present specification is directed towards a computer-implemented method of generating an avatar representative of a target person, wherein the avatar is configured to virtually embody audio, visual and behavioral characteristics of the target person and respond to a user's query based on the target person's life story, the method comprising: receiving first data indicative of the user's query, wherein the first data is in the form of an audio stream; transcribing the first data to generate a natural language text transcript corresponding to the first data; generating, by an embedding engine, a query vector data structure based on the natural language text transcript; generating, by a search engine, at least one text result based on a vector similarity of the query vector data structure with one or more first vector data structures associated with corresponding at least one text file stored in a database; providing as input, to a first artificial neural network, the at least one text result and the corresponding natural language text transcript in order to generate a text response; providing as input, to a second artificial neural network, the text response in order to generate a synthetic audio response; providing as input, to a third artificial neural network, the synthetic audio response in order to generate a video animation of the avatar, wherein the video animation corresponds to the avatar speaking the synthetic audio response; and rendering, on the user's computing device, the synthetic audio response in synchronization with the video animation of the avatar.

Optionally, the natural language text transcript is generated by an artificial speech recognition engine.

Optionally, the vector similarity is determined using a vector cosine similarity function.

Optionally, the at least one text file includes one or more natural language text transcriptions of audio portions of at least one audio/visual video data generated by the target person.

Optionally, the audio/visual video data corresponds to the target person's life story.

Optionally, the audio/visual video data corresponds to the target person reading aloud one or more phrases presented to the target person.

Optionally, the at least one text file additionally includes one or more natural language text generated by the target person. Optionally, the one or more natural language text corresponds to the target person's life story.

Optionally, the one or more first vector data structures are generated as a result of a word-embedding operation performed by the embedding engine on the at least one text file.

Optionally, the first artificial neural network is trained using the one or more first vector data structures. Optionally, the second artificial neural network is trained using the audio portions of said at least one audio/visual video data along with the corresponding at least one text file. Optionally, the third artificial neural network is trained using visual portions of the at least one audio/visual video data along with the corresponding audio portions of the at least one audio/visual video data.

In some embodiments, the present specification is directed towards a computer readable non-transitory medium comprising a plurality of executable programmatic instructions wherein, when said plurality of executable programmatic instructions are executed by a processor in a computing device, a process for generating an avatar representative of a target person is performed, wherein the avatar is configured to virtually embody audio, visual and behavioral characteristics of the target person and respond to a user's query based on the target person's life story, said plurality of executable programmatic instructions comprising: programmatic instructions, stored in said computer readable non-transitory medium, for receiving first data indicative of the user's query, wherein the first data is in the form of an audio stream; programmatic instructions, stored in said computer readable non-transitory medium, for transcribing the first data to generate a natural language text transcript corresponding to the first data; programmatic instructions, stored in said computer readable non-transitory medium, for generating, by an embedding engine, a query vector data structure based on the natural language text transcript; programmatic instructions, stored in said computer readable non-transitory medium, for generating, by a search engine, at least one text result based on a vector similarity of the query vector data structure with one or more first vector data structures associated with corresponding at least one text file stored in a database; programmatic instructions, stored in said computer readable non-transitory medium, for providing as input, to a first artificial neural network, the at least one text result and the corresponding natural language text transcript in order to generate a text response; programmatic instructions, stored in said computer readable non-transitory medium, for providing as input, to a second artificial neural network, the text response in order to generate a synthetic audio response; programmatic instructions, stored in said computer readable non-transitory medium, for providing as input, to a third artificial neural network, the synthetic audio response in order to generate a video animation of the avatar, wherein the video animation corresponds to the avatar uttering the synthetic audio response; and programmatic instructions, stored in said computer readable non-transitory medium, for rendering, on the user's computing device, the synthetic audio response in synchronization with the video animation of the avatar.

Optionally, the natural language text transcript is generated by an artificial speech recognition engine.

Optionally, the vector similarity is determined using a vector cosine similarity function.

Optionally, the at least one text file includes one or more natural language text transcriptions of audio portions of at least one audio/visual video data generated by the target person. Optionally, the audio/visual video data corresponds to the target person's life story.

Optionally, the audio/visual video data corresponds to the target person reading out one or more phrases presented to the target person.

Optionally, the at least one text file additionally includes one or more natural language text generated by the target person.

Optionally, the one or more natural language text corresponds to the target person's life story.

Optionally, the one or more first vector data structures are generated as a result of a word-embedding operation performed by the embedding engine on the at least one text file.

Optionally, the first artificial neural network is trained using the one or more first vector data structures.

Optionally, the second artificial neural network is trained using the audio portions of said at least one audio/visual video data along with the corresponding at least one text file.

Optionally, the third artificial neural network is trained using visual portions of the at least one audio/visual video data along with the corresponding audio portions of the at least one audio/visual video data.

In some embodiments, the present specification is directed toward a computer-implemented method of generating an avatar representative of a target person, wherein the avatar is configured to virtually embody audio, visual and behavioral characteristics of the target person and respond to a user's query based on the target person's life story, the method comprising: receiving first data indicative of the user's query, wherein the first data is in the form of an audio stream; transcribing the first data to generate a natural language text transcript corresponding, wherein the transcription is performed manually; generating, by an embedding engine, a query vector data structure based on the natural language text transcript; generating, by a search engine, at least one text result based on a vector similarity of the query vector data structure with one or more first vector data structures associated with corresponding at least one text file stored in a database, wherein the at least one text file includes one or more natural language text transcriptions of audio portions of at least one audio/visual video data generated by the target person, and wherein the audio/visual video data corresponds to the target person's life story; providing as input, to a first artificial neural network, the at least one text result and the corresponding natural language text transcript in order to generate a text response, wherein the first artificial neural network is trained using one or more first vector data structures, and wherein the one or more first vector data structures are generated as a result of a word-embedding operation performed by the embedding engine on the at least one text file; providing as input, to a second artificial neural network, the text response in order to generate a synthetic audio response; providing as input, to a third artificial neural network, the synthetic audio response in order to generate a video animation of the avatar, wherein the video animation corresponds to the avatar uttering the synthetic audio response; and rendering, on the user's computing device, the synthetic audio response in synchronization with the video animation of the avatar.

Optionally, the vector similarity is determined using a vector cosine similarity function.

Optionally, the second artificial neural network is trained using the audio portions of said at least one audio/visual video data along with the corresponding at least one text file.

Optionally, the third artificial neural network is trained using visual portions of the at least one audio/visual video data along with the corresponding audio portions of the at least one audio/visual video data.

The aforementioned and other embodiments of the present specification shall be described in greater depth in the drawings and detailed description provided below.

### BRIEF DESCRIPTION OF THE DRAWINGS

The accompanying drawings illustrate various embodiments of systems, methods, and embodiments of various other aspects of the disclosure. Any person with ordinary skills in the art will appreciate that the illustrated element boundaries (e.g., boxes, groups of boxes, or other shapes) in the figures represent one example of the boundaries. It may be that in some examples one element may be designed as multiple elements or that multiple elements may be designed as one element. In some examples, an element shown as an internal component of one element may be implemented as an external component in another and vice versa. Furthermore, elements may not be drawn to scale. Non-limiting and non-exhaustive descriptions are described with reference to the following drawings. The components in the figures are not necessarily to scale, emphasis instead being placed upon illustrating principles.

FIG. 1A is a block diagram showing a client-server architecture in which systems and methods of the present specification may be implemented, in accordance with some embodiments of the present specification;

FIG. 1B is a block diagram showing a life module, in accordance with some embodiments of the present specification; and

FIG. 2 is a flowchart of a plurality of exemplary steps of a method for generating a response to a user's query using an alter ego or avatar of a target person, in accordance with some embodiments of the present specification.

### DETAILED DESCRIPTION

The present specification is directed towards multiple embodiments. The following disclosure is provided in order to enable a person having ordinary skill in the art to practice the invention. Language used in this specification should not be interpreted as a general disavowal of any one specific embodiment or used to limit the claims beyond the meaning of the terms used therein. The general principles defined herein may be applied to other embodiments and applications without departing from the spirit and scope of the invention. Also, the terminology and phraseology used is for the purpose of describing exemplary embodiments and should not be considered limiting. Thus, the present invention is to be accorded the widest scope encompassing numerous alternatives, modifications and equivalents consistent with the principles and features disclosed. For purpose of clarity, details relating to technical material that is known in the technical fields related to the invention have not been described in detail so as not to unnecessarily obscure the present invention.

In various embodiments, a computing device includes an input/output controller, at least one communications interface and system memory. The system memory includes at least one random access memory (RAM) and at least one read-only memory (ROM). These elements are in communication with a central processing unit (CPU) to enable operation of the computing device. In various embodiments, the computing device may be a conventional standalone computer or alternatively, the functions of the computing device may be distributed across multiple computer systems and architectures.

In some embodiments, execution of a plurality of sequences of programmatic instructions or code enable or cause the CPU of the computing device to perform various functions and processes. In alternate embodiments, hard-wired circuitry may be used in place of, or in combination with, software instructions for implementation of the processes of systems and methods described in this application. Thus, the systems and methods described are not limited to any specific combination of hardware and software.

The term “module”, “application”, “component” or “engine” used in this disclosure may refer to computer logic utilized to provide a desired functionality, service or operation by programming or controlling a general purpose processor. Stated differently, in some embodiments, a module, application or engine implements a plurality of instructions or programmatic code to cause a general purpose processor to perform one or more functions. In various embodiments, a module, application or engine can be implemented in hardware, firmware, software or any combination thereof. The module, application or engine may be interchangeably used with unit, logic, logical block, component, or circuit, for example. The module, application or engine may be the minimum unit, or part thereof, which performs one or more particular functions.

In the description and claims of the application, each of the words “comprise”, “include”, “have”, “contain”, and forms thereof, are not necessarily limited to members in a list with which the words may be associated. Thus, they are intended to be equivalent in meaning and be open-ended in that an item or items following any one of these words is not meant to be an exhaustive listing of such item or items, or meant to be limited to only the listed item or items. It should be noted herein that any feature or component described in association with a specific embodiment may be used and implemented with any other embodiment unless clearly indicated otherwise.

It must also be noted that as used herein and in the appended claims, the singular forms “a,” “an,” and “the” include plural references unless the context dictates otherwise. Although any systems and methods similar or equivalent to those described herein can be used in the practice or testing of embodiments of the present disclosure, the preferred, systems and methods are now described.

The term “artificial neural network” used in this disclosure may refer to a computational model that consists of several processing elements that receive inputs and deliver outputs based on their predefined activation functions.

The term “alter ego” or “avatar” used in this disclosure may refer to a graphical representation of a user possessing or portraying the user's behavioral characteristics or persona.

One of ordinary skill in the art would appreciate that the present disclosure, and appended claims, are directed toward solving a specific technical problem that arises when attempting to efficiently and accurately capture defining characteristics of a human being to enable a computer-generated avatar to embody such defining characteristics when responding to a query. Typically, avatars fail to properly embody defining characteristics of a specific person and, therefore, are often programmed to generically reflect a class of people. Creating avatars that can efficiently capture, and accurately represent, a unique individual's life experiences require an improvement in underlying data capture and processing technologies.

### Overview

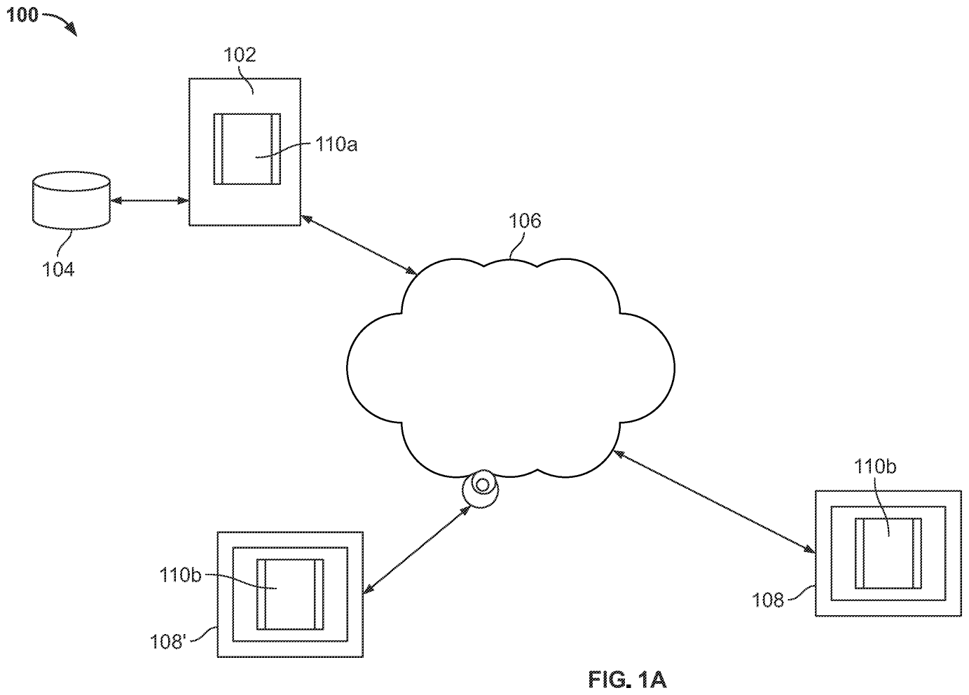

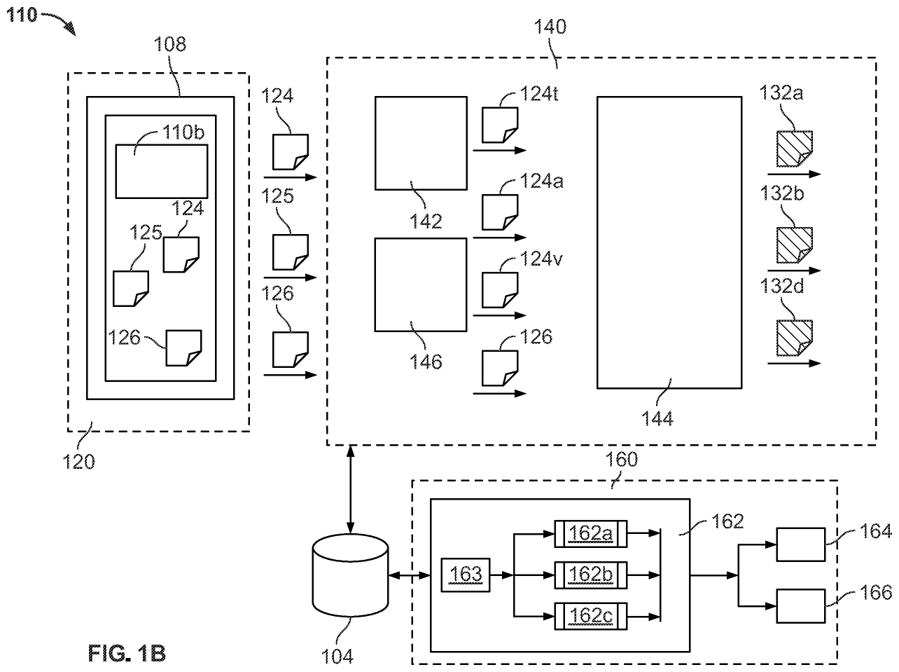

FIG. 1A is a block diagram illustration of a client-server architecture 100 in which systems and methods of the present specification may be implemented, in accordance with various embodiments. As shown in FIG. 1A, a plurality of client computing devices 108 are in data communication with at least one server 102 through a wired and/or wireless network 106. In some embodiments, the network 106 may be a LAN (Local Area Network), WAN (Wide Area Network) or the Internet. While any number of client computing devices 108 may be connected to the network 106, the present specification is being described (for brevity) using first and second client computing devices 108 and 108′ (collectively referenced by the numeral 108). In some embodiments, the at least one server 102 may be implemented by a cloud of computing platforms operating together as server 102.

In some embodiments, the at least one server 102 implements a server-side component or application 110a of a life module 110 while each of the client computing devices 108 implements a client-side component or application 110b of the life module 110. The architecture, functions and characteristics of the life module 110 are described later in this specification with reference to FIG. 1B. It should be appreciated that the functionalities related to various modules and engines of the life module 110 may be distributed, without limitation, across the server-side and client-side components or applications 110a, 110b. In some embodiments, the client-side component or application 110b is a web browser in which case most of the modules and engines are integrated into the server-side component or application 110a.

Referring now to FIGS. 1A and 1B, the first client computing device 108 is associated with a first person (also referred to, hereinafter, as a user) while the second client computing device 108′ is associated with a second person. In some embodiments, the second person is an interviewee (also referred to, interchangeably, as a ‘target person’) whose life story is being captured, processed and incarnated, by the life module 110, while the first person or user is an interviewer who prompts the second person to share various aspects of their life story. The term “life story” shall mean all events, people, activities, preferences, and other data that are personal to the target person and are viewed by the target person as meaningful aspects of the target person's life.

In various embodiments, the client-side component or application 110b generates at least one GUI (Graphical User Interface) that enables a) the interviewer and interviewee to generate respective login credentials (login ID and password), b) the interviewer to invite and connect with the interviewee in order to capture the interviewee's life story. In various embodiments, the interviewer may invite the interviewee by sending one or more emails and/or instant messages, c) the interviewer and interviewee to have an audio-visual virtual meeting, d) a plurality of phrases to be presented to the interviewee in an offline mode. The interviewee is prompted to read the plurality of phrases so that the interviewee's audio and video, while reading the plurality of phrases, is recorded. Such recorded audio and video data of the interviewee is used to train one or more artificial neural networks of the life module 110. In various embodiments, all audio and video data is processed (at the client-side or server-side) in order to remove noise/clicks and other aural artifacts, e) the interviewee to input textual responses to one or more questions or to simply record textual journal entries related to their life story in an offline mode, f) the interviewee to upload one or more pre-recorded audio or audio/visual video data indicative of journal entries related to their life story in an offline mode, and g) the interviewee to upload scanned pictures of handwritten journal entries related to their life story in an offline mode.

In some embodiments, the interviewer or the life module 110 may present a questionnaire to generally guide the interviewee into sharing stories and events related to various aspects and stages of the interviewee's life story. In some embodiments, the questionnaire may be custom generated and may include simple generic queries intended to bring out various aspects, events and personality of the interviewee. In some embodiments, the client-side component or application 110b may include one or more specialized questionnaires that the interviewer or the life module 110 may select to share with the interviewee. Such specialized questionnaire may include, for example, personality capture modules (software programs) developed by William Sims Bainbridge for gathering insights about the interviewee. The interviewer or the life module 110 is enabled to choose portions of the specialized questionnaires for sharing with the interviewee.

In some embodiments, the client-side component or application 110b is configured to conduct an automated Q&A session with the interviewee wherein each question of the questionnaire is presented, in a timed manner, to the interviewee in a GUI generated by the client-side component or application 110b and the interviewee's audio and video responses are recorded. Alternatively, the automated Q&A session may present each question of the questionnaire and the interviewee may input textual responses into a GUI generated by the client-side component or application 110b.

The interviewee may thus share their life story in real-time over an audio-visual virtual meeting and/or offline. In either case, the interviewee's client-side component or application 110b captures the interviewee's inputs in the form of at least one audio/visual video file 124, at least one text file 125 and one or more picture/image files 126 (FIG. 1B). It should be appreciated that date and timestamps are automatically generated by the system and associated with the at least one audio/visual video file 124 and the at least one text file 125. In some embodiments, date and timestamps may also be associated with the one or more picture/image files 126 if such date and timestamps data is provided by the interviewee for the one or more picture/image files 126.

In some embodiments, at the completion of a real-time audio-visual virtual meeting, the interviewer's audio as well as the interviewee's audio and video (comprising data in the form of prompt-response pairs) are captured by the interviewee's client-side component or application 110b as the at least one audio/visual video file 124. In some embodiments, the at least one audio/visual video file 124 includes interviewee's audio and video responses (comprising data in the form of prompt-response pairs) to the automated Q&A session. In some embodiments, the at least one audio/visual video file 124 includes additional audio and video data (that is not in the form of prompt-response pairs) corresponding to the interviewee reading out a plurality of phrases presented on a screen of the interviewee's client-side component or application 110b. In some embodiments, the at least one audio/visual video file 124 further includes one or more pre-recorded (offline) audio or audio/visual video data (that is not in the form of prompt-response pairs) indicative of journal entries related to the interviewee's life story.

In some embodiments, the at least one text file 125 includes the interviewee's textual responses to one or more questions and/or textual responses to questions presented during the automated Q&A session related to their life story. Such textual data is in the form of prompt-response pairs. In some embodiments, the at least one text file 125 includes textual journal entries that are not in the form of prompt-response pairs. In embodiments, the uploaded one or more scanned pictures of handwritten journal entries of the interviewee undergo intelligent character recognition (ICR) in order to extract text. In some embodiments, the at least one text file 125 also includes the extracted text that is, typically, not in the form of prompt-response pairs.

In some embodiments, the one or more picture/image files 126 are associated with one or more aspects of the interviewee's life story, stage or phase of life, event (such as, for example, a birthday party, vacation, child birth, wedding, get-together, speaking engagement, etc.), milestone or any other aspect of the interviewee's life.

In accordance with various aspects of the present specification, the interviewee's life story and journal entries (in the form of at least one audio/visual video file 124, the at least one text file 125 and one or more picture/image files 126) is processed by the life module 110 in order to generate an alter ego or avatar. In embodiments, the alter ego or avatar is characterized by possessing a plurality of personality traits of the interviewee. That is, the alter ego or avatar is configured to visually appear and sound like the interviewee.

It should be appreciated that the interviewee may provide a record of their life story over a plurality of sessions that may be distributed over a span of time period. Each time the interviewee shares incremental data related to their life story, the life module 110 processes the incremental data.

In accordance with some aspects of the present specification, the life module 110 enables a user to access and interact with the alter ego or avatar of the interviewee. For example, the user may ask a plurality of questions, related to the interviewee's life story, from the alter ego or avatar and the alter ego or avatar may respond (audio and/or visual) based on the interviewee's life story.

In some embodiments, the client-side component 110b allows the interviewee to associate restricted access to some portions of the life story. For example, the interviewee may mark some portions of their life story as private and restricted for access to one or more predefined authorized users only whereas some portions of their life story may be marked for unrestricted sharing. Accordingly, if a user poses a query to the alter ego or avatar that falls in the realm of having been marked private (for restricted access) then the alter ego or avatar is configured so that a response to the query is provided only if the user is one of the predefined authorized users. If the user is not authorized, the alter ego or avatar is configured to not provide a response to the user's query.

In embodiments, the at least one server 102 is in data communication with a database system 104. The database system 104 described herein may be, include, or interface to, for example, an Oracle™ relational database sold commercially by Oracle Corporation. Other databases, such as Informix™, DB2 (Database 2) or other data storage, including file-based, or query formats, platforms, or resources such as OLAP (On Line Analytical Processing), SQL (Structured Query Language), a SAN (storage area network), Microsoft Access™ or others may also be used, incorporated, or accessed. The database system 104 may comprise one or more such databases that reside in one or more physical devices and in one or more physical locations. In some embodiments, the database system 104 may store a plurality of data (audio, video, textual, image and vector structure data) related to the life module 110 and the interviewee's life story.

### Life Module 110

As shown in FIG. 1B, in some embodiments, the life module 110 has a plurality of modules and engines that are organized into life stories input (LSI) system 120, life stories processing (LSP) system 140 and life stories output (LSO) system 160.

### Life Stories Input (LSI) system 120

In some embodiments, the LSI system 120 includes the client-side component 110b that is installed on the user's client computing device 108. The client-side component 110b is configured to capture the interviewee's life story.

Referring now to FIGS. 1A and 1B, simultaneously, in embodiments, the at least one video file 124 comprises audio data and visual data indicative of the content of the interviewee's life story, which may include visual features such as, for example, appearance while talking and audio features such as, for example, mannerism, style and tone of speech. The one or more picture/image files 126 that may be associated with one or more aspects of the interviewee's life story, stage or phase of life, event (such as, for example, a birthday party, vacation, childbirth, wedding, get-together, speaking engagement, etc.), milestone or any other aspect of the interviewee's life may accompany or be associated with the at least one video file 124. The at least one text file 125 may also accompany and be associated with the at least one video file 124.

In some embodiments, the client-side component 110b is configured to record and store, locally, the at least one video file 124, the at least one text file 125 and the one or more picture/image files 126 in the interviewee's client computing device 108. Subsequently, the locally stored video file 124, text file 125, and picture/image files 126 are transmitted to the at least one server 102, over the network 106, for storage. It should be appreciated that local recording and storage of the video file 124, text file 125, and picture/image files 126 ensures high quality of data as the acquisition (recording and storing) of data is not dependent on the quality and availability of data transfer bandwidth of the network 106. The locally stored video file 124, text file 125, and picture/image files 126 can be conveniently transmitted to the at least one server 102 at a time when availability and quality of network bandwidth is optimal.

In some embodiments, each of the video file 124, text file 125 and the one or more picture/image files 126 may also have associated metadata. For example, the metadata may comprise data such as, but not limited to, file size, file name, file type or extension (such as, for example, MPEG for the video file 124 and JPEG for the one or more picture/image files 126), file creation or submission date and time (that is, a date and time stamp when the file is created in the system and/or when the file is submitted/inputted into the system for storage). It should be appreciated that the metadata is automatically generated in the system by virtue of the event of creation of the at least one audio/visual video file 124, the at least one text file 125 as well as submission of the one or more picture/image files 126 into the system by the interviewee.

### Life Stories Processing (LSP) System 140

In some embodiments, the LSP system 140 includes an Automatic Speech Recognition (ASR) engine 142 (such as, for example a Dragon speech recognition engine), an embedding engine 144, and an audio grabber 146.

In some embodiments, the audio grabber 146 enables the audio data portions of the at least one video file 124 to be extracted (from the at least one video file 124) and transcribed into natural language textual words that form first data indicative of at least one text file 124t. In some embodiments, the first data indicative of the at least one text file 124t includes transcribed and compiled prompt-response pairs resulting from the interviewer and interviewee interactions in the real-time audio-visual virtual meeting and interviewee's response to each question in the automated Q&A sessions. In some embodiments, the first data indicative of the at least one text file 124t also includes portions of the at least one text file 125 that includes the interviewee's textual responses to one or more questions presented during the automated Q&A session. It should be appreciated that this first set or portion of the at least one text file 124t may be in the form of prompt-response pairs.

In some embodiments, the first data indicative of the at least one text file 124t also includes transcription of the spoken words or utterances of the interviewee while reading out the plurality of phrases presented on a screen of the interviewee's client-side component or application 110b. Additionally, the first data indicative of the at least one text file 124t further includes transcription of the spoken words or utterances of the interviewee in the form of journal entries related to the interviewee's life story. In some embodiments, the first data indicative of the at least one text file 124t also includes portions of the at least one text file 125 that includes textual journal entries and text extracted (using ICR) from scanned pictures of handwritten journal entries. It should be appreciated that this second set or portion of the at least one text file 124t is not in the form of prompt-response pairs.

Thus, the at least one text file 124t, representative of the first data, includes the first set or portion that is in the form of prompt-response pairs and the second set or portion that is not in the form of prompt-response pairs. In some embodiments, the transcribed portions of the first data indicative of the at least one text file 124t is tagged or associated with the same date and timestamp as that of the corresponding portions of the at least one audio/visual video file 124. The portions of the at least one text file 125 that are compiled into the first data indicative of the at least one text file 124t are associated with the date and timestamps of the corresponding portions of the at least one text file 125.

In some embodiments, the transcriptions are performed manually. For manual processing, an administrator may use their client computing device to access the video file 124 and distribute the video file 124 to one or more individuals tasked to transcribe. In some embodiments, the LSP system 140 is configured to automatically generate the transcriptions of the audio portions of the video file 124. Specifically, the LSP system 140 implements an Automatic Speech Recognition (ASR) engine 142 that receives the audio portions of the video file 124 as input and converts the spoken words or utterances to natural language textual words.

In some embodiments, the audio grabber 146 is configured to compile the acoustic or audio data portions of the at least one video file 124 (that were separated or extracted from the at least one video file 124) into second data indicative of at least one audio file 124a. In some embodiments, the second data indicative of the at least one audio file 124a includes one or more of: the interviewee's audio data resulting from the interviewer and interviewee interactions in the real-time audio-visual virtual meeting, interviewee's audio based response to each question in the automated Q&A sessions, the spoken words or utterances of the interviewee while reading out the plurality of phrases presented on a screen of the interviewee's client-side component or application 110b, and the spoken words or utterances of the interviewee in the form of journal entries related to the interviewee's life story.

In some embodiments, the LSP system 140 is configured to compile the visual data (that is, video without audio) that remains after the audio grabber 146 has extracted the acoustic or audio data, from the at least one video file 124 into third data indicative of at least one visual file 124v. In embodiments, the at least one visual file 124v includes the visual, gestural or appearance characteristics of the interviewee. Additionally, the one or more picture/image files 126 form fourth data indicative of the interviewee's life story.

The first data indicative of at least one text file 124t, the second data indicative of at least one audio file 124a, the third data (corresponding to the at least one visual file 124v) indicative of the visual or appearance characteristics of the interviewee and fourth data, corresponding to the one or more picture/image files 126, indicative of the interviewee's life story are stored in the database 104 in association with the interviewee's identification (such as, for example, a login ID). In some embodiments, the first data indicative of the at least one text file 124t is stored in the database 104 in association with the related date and timestamp. Additionally, in some embodiments, each of the second data indicative of the at least one audio file 124a and the third data indicative of the at least one visual file 124v is stored in the database 104 in association with the respective date and timestamps. Consequently, for the interviewee, the second data (data indicative of the at least one audio file 124a) can be paired or related with the corresponding third data (indicative of the at least one visual file 124v) based on the associated date and timestamps when accessed from the database system 104. Also, for the interviewee, the transcribed portions of the first data (indicative of the at least one text file 124t) can be paired or related with the corresponding second data indicative of the at least one audio file 124a based on the associated date and timestamps when accessed from the database system 104.

### Embedding Engine 144

In some embodiments, an embedding refers to a numerical representation of a piece of information, for example, text, documents, images, audio, etc. The representation captures the semantic meaning of what is being embedded, making it robust for a semantic search based query-response pipeline of the present specification.

In some embodiments, the embedding engine 144 is configured to perform embedding operations or functions on the first, second, and fourth data. Consequently, the first data indicative of the at least one text file 124t is represented as one or more first vector data structures 132a, the second data indicative of the at least one audio file 124a is represented as one or more second vector data structures 132b, and the fourth data, corresponding to the one or more picture/image files 126, indicative of the interviewee's life story is represented as one or more fourth vector data structures 132d. In some embodiments, the second data indicative of the at least one audio file 124a as well as the third data (corresponding to the at least one visual file 124v) indicative of the visual or appearance characteristics of the interviewee are encoded into respective digital formats.

In some embodiments, the one or more fourth vector data structures 132d (representing image vectors) are additionally associated with a caption, a label, or any other text string, describing a conceptual representation of the pictures or images that form the fourth data.

Subsequently, the one or more first vector data structures 132a are stored in the database 104 in association with the first data, the one or more second vector data structures 132b are stored in the database 104 in association with the second data, and the one or more fourth vector data structures 132d are stored in the database 104 in association with the fourth data.

In some embodiments, a word embedding is implemented. Word embedding is a mapping of natural language text to a vector of real numbers in a continuous space. Word embedding is used as a mechanism for reasoning over natural language sentences. In some embodiments, the embedding engine 144 implements a plurality of instructions or programmatic code which, when executed, perform a word embedding operation on the at least one text file 124t in order to generate the one or more first vector data structures 132a. In some embodiments, the at least one text file 124t is subjected to tokenization to output a plurality of tokens that are then embedded into the one or more first vector data structures 132a.

In some embodiments, the one or more first vector data structures 132a capture the context of the words, phrases, and sentences in the at least one text file 124t thereby representing the syntactic structure and semantic information (that is, the meaning) of the words, phrases and sentences in the at least one text file 124t. Consequently, the one or more first vector data structures 132a encode a plurality of characteristic features such as, but not limited to, the theme, keywords, emotional state, sentiment and the context including the intentions, beliefs and implicatures associated with the first data. In some embodiments, the embedding engine 144 is configured to use at least one machine learning model in order to perform word embedding. In some embodiments, the machine learning model is a trained Long Short Term Memory (LSTM) network, Gated Recurrent Unit (GRU) or a convolutional neural network (CNN). In various embodiments, the machine learning model may be trained using learning algorithms such as, for example, Word2vec, GloVe, Doc2Vec, and Paragraph2Vec. The first data indicative of the at least one text file 124t is provided as input to a trained neural network comprising embedding encoders and decoders, and the encoders process the first data in order to generate the first vector data structure 132a.

In alternate embodiments, the embedding engine 144 may be configured to use other methods for word embedding such as, but not limited to, dimensionality reduction on a word co-occurrence matrix, probabilistic models, explainable knowledge base method, and explicit representation in terms of the context in which words appear.

Thus, in some embodiments, the first data indicative of the at least one text file 124t is contextualized (using, for example, 768-dimension natural language contextual embedding vectors per sentence/phrase) to generate the one or more first vector data structures 132a. The one or more first vector data structures 132a are indexed and stored in the database system 104 in association with the corresponding first data.

In some embodiments, an audio embedding is implemented. Audio is defined as any human-hearable sound and audio embedding, as used in this specification refers to the process of converting audio files (.mp3, .wav, etc.) into vector representations. In some embodiments, the embedding engine 144 implements a plurality of instructions or programmatic code which when executed perform an audio embedding operation on the at least one audio file 124a in order to generate the one or more second vector data structures 132b. In some embodiments, the one or more second vector data structures 132b include a plurality of characterizing features of the interviewee's voice in the second data indicative of the at least one audio file 124a. In various embodiments, the plurality of characterizing features of the interviewee's voice includes attributes such as, but not limited to, pitch, cadence, emotions or feelings (happy, sad, upset, etc.), speed, intonation, style, tone, accent, gender, guttural or nasal, and intensity. The plurality of characterizing features may be extracted by processing audio parameters such as, for example, a power spectrum, frequency and waveform associated with the second data. In some embodiments, the audio parameters may be determined using a vocoder. As known to persons of ordinary skill in the art, a vocoder is an audio processor (implemented in hardware and/or software) that analyzes an input speech to determine the audio parameters. In some embodiments, the embedding engine 144 is configured to use at least one machine learning model in order to perform audio embedding. In some embodiments, the machine learning model is a trained Recurrent Neural Network (RNN).

Thus, in some embodiments, the second data indicative of the at least one audio file 124a is contextualized to generate the one or more second vector data structures 132b. The one or more second vector data structures 132b are indexed and stored in the database system 104 in association with the corresponding second data.

In some embodiments, an image embedding is implemented. Image embedding is a lower-dimensional representation of an image. In other words, it is a dense vector representation of the image. In some embodiments, the embedding engine 144 implements a plurality of instructions or programmatic code which, when executed, perform image embedding with respect to the fourth data, corresponding to the one or more picture/image files 126, indicative of the interviewee's life story. In some embodiments, the embedding engine 144 is configured to use at least one machine learning model in order to perform image embedding. In some embodiments, the at least one machine learning model is a trained convolutional neural network (CNN).

As a result of the image embedding operation, the one or more fourth vector data structures 132d include a plurality of characteristic features of the one or more picture/image files 126 such as, but not limited to, objects, places, things or items, individuals, context, actions and events. Thus, in some embodiments, the fourth data indicative of the one or more picture/image files 126 is contextualized to generate the one or more fourth vector data structures 132d. The one or more fourth vector data structures 132d are indexed and stored in the database system 104 in association with the corresponding fourth data.

It should be appreciated that, in some embodiments, portions of the one or more first vector data structures 132a, second vector data structures 132b, and fourth vector data structures 132d that are in the form of prompt-response pairs in the corresponding first, second, and fourth data (for example, the interviewee's audio and video from the real-time audio-visual virtual meeting, audio and video responses to the automated Q&A sessions, and textual responses to questions presented during the automated Q&A session) are indexed and stored separately from those portions of the one or more first vector data structures 132a, second vector data structures 132b, and fourth vector data structures 132d that are not in the form of prompt-response pairs in the corresponding first, second, and fourth data (for example, interviewee's journal entries, readouts of phrases presented on a screen, extracted text from scanned pictures of handwritten journal entries, and one or more picture/image files 126).

It should be appreciated that, in various embodiments, the one or more machine learning models implemented by the embedding engine 144 may include one or more support vector machines, linear regression models, clustering analysis models, boosted decision trees, neural networks, deep learning models or a combination thereof.

### Life Stories Output (LSO) System 160

In embodiments, the LSO system 160 includes an alter ego or avatar generation engine 162 comprising first machine learning model 162a, second machine learning model 162b, and third machine learning model 162c, a contextual search engine 163, a display screen 164 and an audio output device 166. In some embodiments, each of the first machine learning model 162a, second machine learning model 162b, and third machine learning model 162c is an artificial neural network (ANN). In various embodiments, each of the first machine learning model 162a, second machine learning model 162b, and third machine learning model 162c may comprise one or more models. In some embodiments, data corresponding to each of the first machine learning model 162a, second machine learning model 162b, and third machine learning model 162c is stored in the database system 104. It should be appreciated that, in some embodiments, some or all functional elements of the LSO system 160 may be implemented in a user's client computing device 108. In some embodiments, some or all functional elements of the LSO system 160 may be implement in the at least one server 102. In some embodiments, the display screen 164 and audio output device 166 are built-in elements of the user's client computing device 108.

In embodiments, the contextual search engine 163 includes a plurality of instructions or programmatic code which when executed configure the contextual search engine 163 to receive a vector data structure, perform a contextual lookup in the database system 104 based on vector similarity (for example, using vector cosine similarity function) and output one or more results based on the contextual similarity lookup.

In some embodiments, the display screen 164 may be, for example, a liquid crystal display (LCD), an interferometric modulator display (IMOD), a light emitting diode (LED), or any other display technology known to persons of ordinary skill in the art. In some embodiments, the audio output device 166 is a sound card or an external adaptor for processing audio data and a device for connecting to an audio output. The audio output may be, for example, a direct audio output such as a speaker, headphones, or an HDMI audio. The audio output is not limited to any specific output methodology or device and may depend on how the client device is implemented.

### Alter Ego or Avatar Generation Engine 162

In accordance with aspects of the present specification, the LSO system 160 implements an alter ego or avatar generation engine 162 that includes a plurality of instructions or programmatic code which, when executed, generates and present an animated 3D face/head and shoulders avatar of the interviewee. In embodiments, the avatar is configured to simulate the visual and auditory characteristics of the interviewee. Stated differently, the 3D face/head and shoulders avatar of the interviewee simulates the personality of the interviewee while interacting with one or more users. Additionally, the avatar of the interviewee is enabled to respond to a user's query with an appropriate answer on the context (stored in the database 104) of the life story and the personality traits of the interviewee.

In some embodiments, a GPU-enabled cloud worker is provisioned to train the alter ego or avatar generation engine 162. The worker downloads the latest first machine learning model 162a, second machine learning model 162b, and third machine learning model 162c and all interviewee data (first, second, third and fourth data as well as the corresponding first vector data structure 132a, second vector data structure 132b, and fourth vector data structure 132d). In some embodiments, parallel training/fine-tuning of the first machine learning model 162a, second machine learning model 162b, and third machine learning model 162c is started. Upon completion of training, the new models are uploaded to the database system 104 in order to replace the previous versions.

### First ANN 162a

In some embodiments, the one or more first vector data structures 132a are provided as input to the first ANN 162a. This enables the first ANN 162a to be trained to understand the context of the words, phrases and sentences in the first data indicative of the text file 124t thereby comprehending the syntactic structure and semantic information (that is, the meaning) of the words, phrases and sentences (some of which are in the form of prompt-response pairs while some are not) in the text file 124t. The training enables the first ANN 162a to also understand the plurality of prompt-response pairs in the first data indicative of the at least one text file 124t.

In some embodiments, prior to training the first ANN 162a on the first vector data structure 132a, the first ANN 162a may be initially trained on known and validated question/prompt and response pairs. For example, a corpus of Frequently Asked Questions (FAQs) may be used as a labeled set of training data. The semantic similarities in such FAQs are used in combination with the first vector data structure 132a to build a training set of questions and responses. Consequently, the first ANN 162a is further enabled to identify the relative positions of the plurality of prompts and responses in the at least one text file 124t and then correlate them to one another.

As a result, when at least one text is provided as input, the first ANN 162a is configured to generate at least one natural language based textual response output based on the interviewee's life story. In embodiments, the response output captures the response characteristics of the interviewee so that the response output corresponds to how the interviewee would phrase their response. In some embodiments, the response may include other potential categorical or linear outputs including emotional state, sentiment, etc.

In some embodiments, the first ANN 162a is a Natural Language Transformer Model, Long Short Term Memory (LSTM) network, Gated Recurrent Unit (GRU) or a convolutional neural network (CNN).

### Second ANN 162b

In some embodiments, the second data indicative of the at least one audio file 124a is provided as input to the second ANN 162b for training. For example, the second data may include one or more of a) first audio data comprising the interviewee's audio responses from the real-time audio-visual virtual meetings, b) second audio data comprising the interviewee's audio responses to the automated Q&A sessions, c) third audio data comprising the interviewee's audio corresponding to the interviewee reading out a plurality of phrases presented on a screen of the interviewee's client-side component or application 110b, and d) fourth audio data comprising the interviewee's pre-recorded audio indicative of journal entries. Each of the first, second, third and fourth audio data is provided as input to the second ANN 162b after trimming and noise/click removal for each sentence spoken by the interviewee.

In some embodiments, the second data indicative of the at least one audio file 124a is paired with the corresponding first data indicative of the at least one text file 124t and provided as input to the second ANN 162b for training. It should be appreciated that the first data includes the transcriptions of the first, second, third and fourth audio data.

In some embodiments, the second data indicative of the at least one audio file 124a is correlated with corresponding first data indicative of the at least one text file 124t and the corresponding one or more second vector data structures 132b and provided as input to the second ANN 162b for training. The first data includes the transcriptions of the first, second, third and fourth audio data while the one or more second vector data structures 132b include characterizing features of the interviewee's voice in the second data.

In some embodiments, the second data indicative of the at least one audio file 124a is correlated with corresponding first data indicative of the at least one text file 124t, the corresponding one or more second vector data structures 132b and the corresponding one or more first vector data structures 132a and provided as input to the second ANN 162b for training. The first data includes the textural transcriptions of the first, second, third and fourth audio data, the one or more first vector data structures 132a include the syntactic structure and semantic information related to the first data while the one or more second vector data structures 132b include characterizing features of the interviewee's voice in the second data.

The training process is configured to enable the second ANN 162b to ingest and process the input data in order to be trained to learn the interviewee's voice related attributes such as, but not limited to, pitch, cadence, emotions, sentiments or feelings (happy, sad, upset, etc.), speed, intonation, style, tone, accent, gender, guttural or nasal, and intensity. Since the second vector data is a spoken representation of the corresponding first vector data, the second ANN 162b is configured to correlate the interviewee's voice related attributes, in the second vector data structure 132b, with the syntactic structure and semantic information in the corresponding first vector data structure 132a.

Consequently, during use or operation, upon receiving input text data from the first ANN 162a, the trained second ANN 162b outputs synthetic speech corresponding to the input text, wherein the synthetic speech possesses the interviewee's voice related attributes. Stated differently, when the synthetic speech is outputted as audio (via a speaker of a computing device), the audio sounds like that of the interviewee. In some embodiments, the second ANN 162b is a Recurrent Neural Network (RNN).

### Third ANN 162c

In some embodiments, the third data (video without audio) indicative of the at least one visual file 124v is provided as input to the third ANN 162c for training. For example, the third data may include one or more of a) first visual data comprising the interviewee's video responses from the real-time audio-visual virtual meetings, b) second visual data comprising the interviewee's video responses to the automated Q&A sessions, c) third visual data comprising the interviewee's video corresponding to the interviewee reading out a plurality of phrases presented on a screen of the interviewee's client-side component or application 110b, and d) fourth visual data comprising the interviewee's pre-recorded video indicative of journal entries. Each of the first, second, third and fourth visual data is provided as input to the third ANN 162c.

In some embodiments, the third data indicative of the at least one visual file 124v is paired with the corresponding second data indicative of the at least one audio file 124a and provided as input to the third ANN 162c for training. It should be appreciated that the second data includes the acoustics or audio data corresponding to the first, second, third and fourth visual data.

In some embodiments, the third data indicative of the at least one visual file 124v is correlated with corresponding second data indicative of the at least one audio file 124a and with the corresponding one or more second vector data structures 132b and provided as input to the third ANN 162c for training.

The training process is configured to enable the third ANN 162c to ingest and process the input data in order to be trained to learn a plurality of visual features of the interviewee such as, but not limited to, visual appearance, demeanor, facial characteristics, gestures, movements of the lips, eyes and eyebrows as well as facial expressions while speaking (in general as well as while speaking specific words). In some embodiments, the third ANN 162c is enabled to correlate the interviewee's visual features with the corresponding spoken words and utterances in the second data indicative of the at least one audio file 124a and with the corresponding one or more second vector data structures 132b.

In some embodiments, the alter ego or avatar generation engine 162 is configured to use a deep-fake approach that takes a static image of the interviewee as reference and the third ANN 162c animates the image based on the synthetic speech received as input from the second ANN 162b.

In some embodiments, the third ANN 162c is configured to accept synthetic speech from the second ANN 162b and generate a video stream representing the interviewee's face, facial expressions, demeanor and gestures as the interviewee's avatar speaks or responds.

In some embodiments, the alter ego or avatar generation engine 162 is configured to use active shape modeling to fit a 3D mesh of the interviewee's face onto a 3D avatar framework, photorealistic facial texture (from the third data indicative of the at least one visual file 124v) to UV map over the mesh and the mesh is animated using the third ANN 162c that has been trained through face-mesh datasets. Consequently, during use or operation, upon receiving input audio data, the trained third ANN 162c is configured to output corresponding three-dimensional facial animation using the interviewee's face/head and shoulders avatar.

In some embodiments, the third ANN 162c is at least one of a generative adversarial network (GAN) (designed using networks such as, for example, convolutional neural networks (CNNs), recurrent neural networks (RNNs), or just regular neural networks (ANNs or RegularNets)), a Style Transfer Network or a convolutional neural network (CNN).

During operation, the data indicative of the animated three dimensional avatar of the interviewee as well as data indicative of the synthetic speech of the interviewee are rendered, in synchronization, on the user's client computing device 108.

### A Method of Implementing a Query and Response Conversation with an Avatar

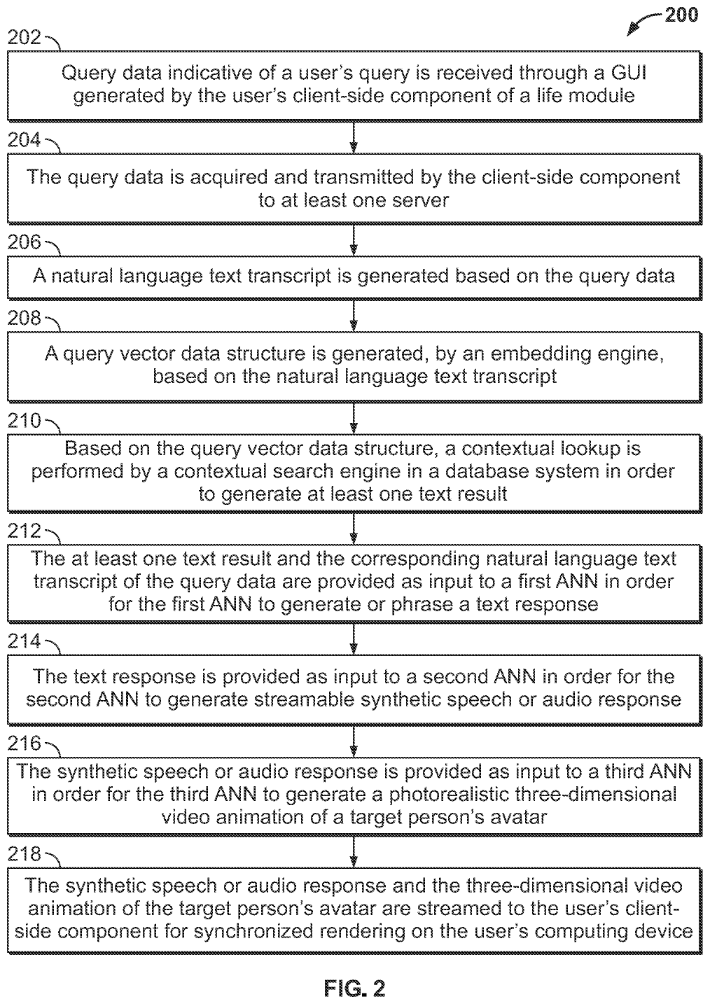

FIG. 2 is a flowchart of a plurality of exemplary steps of a method 200 of generating a response to a query using the alter ego or avatar generation engine 162 of FIG. 1B, in accordance with some embodiments of the present specification. In embodiments, the method 200b is executed in the environment or system 100 of FIG. 1A. It should be noted herein that all modules and engines described herein are configured to perform the functions that are described with respect to those modules and engines.

In an exemplary, non-limiting scenario, the method 200b is executed when a target person shares their legacy with a user as a result of which, the user logs in the server-side component 110a of the life module 110 using the client-side component 110b of the life module 110 installed on their client computing device 108 and initiates a video call with the target person's avatar generated by the alter ego or avatar generation engine 162.

In some embodiments, a GPU-enabled cloud worker is provisioned to operate the avatar. The worker downloads the alter ego or avatar generation engine 162 with the latest ANN models. The worker then loads the alter ego or avatar generation engine 162 to memory and establishes a peer-to-peer connection with the calling user (via WebRTC or similar) indicating that it is ready to talk. As described with reference to FIG. 1A, the database 104 stores a plurality of data processed by the life module 110, wherein the plurality of data (textual, vector, audio, visual, and a plurality of machine learning models) corresponds to a target person and their life story.

Referring now to FIGS. 1A, 1B and 2 simultaneously, at step 202, data indicative of a user's query (“query data”) is received through a GUI generated by the user's client-side component 110b (on the user's client computing device 108) of the life module 110. In some embodiments, the query data is in the form of the user's speech or audio utterance that is acquired by the client-side component 110b through a microphone associated with the user's client computing device 108.

At step 204, the query data is acquired and transmitted by the client-side component 110b to the at least one server 102.

At step 206, a natural language text transcript is generated based on the query data. In some embodiments, the speech or audio utterance of the query data is processed by the ASR engine 142 in order to convert the speech or audio utterance into the natural language text transcript. In some embodiments, the ASR engine 142 is integrated into the server-side component 110a. However, in some embodiments, the ASR engine 142 is integrated into the client-side component 110b in which case the transcription is generated at the client-side component 110b.

In some embodiments, the query data is streamed to the GPU-enabled cloud worker who forwards the query data (comprising speech or audio) to the ASR engine 142 to generate the natural language text transcript. In some embodiments, the GPU-enabled cloud worker scans for long pauses and sentence/question endings from the streamed query data prior to forwarding it to the ASR engine 142. In some embodiments, the query data is input into the ASR engine 142 in order to generate the natural language text transcript. In embodiments, the natural language text transcript is transmitted to the embedding engine 144.

It should be appreciated that the user's query data may be part of an extended conversation comprising a plurality of previous queries of the user and corresponding responses by the alter ego or avatar generation engine 162. Therefore, in some embodiments, the plurality of previous queries and corresponding responses in the conversation are added (with progressively lowering weights assigned to the previous queries and responses the farther back these are in the conversation) to the input to maintain conversational continuity.

At step 208, a query data vector structure is generated, by the embedding engine 144, based on the natural language text transcript. In some embodiments, the embedding engine 144 performs an embedding operation on the natural language text transcript in order to generate the query vector data structure 205a. It should be noted that the embedding operation is the same as the one that was performed on the first data indicative of the at least one text file 124t.

In some embodiments, the GPU-enabled cloud worker scans the natural language text transcript for stop words prior to the embedding operation being performed by the embedding engine 144. When an end of a statement or question is detected, in the natural language text transcript, the natural language text transcript 203a is forwarded to the embedding engine 144.

At step 210, based on the query vector data structure, a contextual lookup is performed by the contextual search engine 163 in the database system 104 in order to generate at least one text result. In some embodiments, the at least one text result is generated based on a vector similarity or match of the query vector data structure with the one or more first vector data structures 132a associated with the corresponding at least one text file 124t in the database system 104. In embodiments, the contextual lookup is performed on data (in the database system 104) that corresponds to prompt-response pairs as well as on data that does not correspond to prompt-response-pairs in the database system 104. However, in some embodiments, the matches from data that corresponds to prompt-response pairs are weighted higher due to query similarity. In some embodiments, the contextual lookup is based on vector similarity such as, for example, the vector cosine similarity function.

Additionally, in some embodiments, one or more picture/image based results may also be generated based on the contextual lookup of the one or more fourth vector data structures 132d that correspond to the one or more picture/image files 126 stored in the database 104.

At step 212, the at least one text result and the corresponding natural language text transcript of the query data are provided as input to the first ANN (artificial neural network) 162a in order for the first ANN 162a to generate or phrase a text response. In embodiments, the text response output captures the response characteristics of the target person so that the text response output corresponds to how the target person would phrase their text response. In some embodiments, the text response may include other potential categorical or linear outputs including emotional state, sentiment, etc.

At step 214, the text response is provided as input to the second ANN 162b in order for the second ANN 162b to generate synthetic speech or audio response that can be streamed. In embodiments, the synthetic speech or audio response output is characterized by the target person's voice related attributes such as, but not limited to, pitch, cadence, emotions, sentiments or feelings (happy, sad, upset, etc.), speed, intonation, style, tone, accent, gender, guttural or nasal, and intensity.

At step 216, the synthetic speech or audio response is provided as input (that can be streamed) to the third ANN 162c in order for the third ANN 162c to generate a photorealistic three-dimensional video animation of the target person's face/head and shoulders avatar. In embodiments, the photorealistic three-dimensional video animation displays a plurality of visual features of the target person such as, but not limited to, visual appearance, demeanor, facial characteristics, gestures, movements of the lips, eyes and eyebrows as well as facial expressions while speaking.

At step 218, the synthetic speech or audio response and the three-dimensional video animation of the target person's face/head and shoulders avatar are streamed to the user's client-side component 110b for synchronized rendering on the user's computing device.

The above examples are merely illustrative of the many applications of the systems and methods of the present specification. Although only a few embodiments of the present invention have been described herein, it should be understood that the present invention might be embodied in many other specific forms without departing from the spirit or scope of the invention. Therefore, the present examples and embodiments are to be considered as illustrative and not restrictive, and the invention may be modified within the scope of the appended claims.

What is claimed is:

1. A computer-implemented method of generating an avatar representative of a target person, wherein the avatar is configured to virtually embody audio, visual and behavioral characteristics of the target person and respond to a user's query based on the target person's life story, the method comprising:
receiving first data indicative of the user's query, wherein the first data is in the form of an audio stream;
transcribing the first data to generate a natural language text transcript corresponding to the first data;
generating, by an embedding engine, a query vector data structure based on the natural language text transcript;
generating, by a search engine, at least one text result based on a vector similarity of the query vector data structure with one or more first vector data structures associated with corresponding at least one text file stored in a database;
providing as input, to a first artificial neural network, the at least one text result and the corresponding natural language text transcript in order to generate a text response;
providing as input, to a second artificial neural network, the text response in order to generate a synthetic audio response;
providing as input, to a third artificial neural network, the synthetic audio response in order to generate a video animation of the avatar, wherein the video animation corresponds to the avatar speaking the synthetic audio response; and
rendering, on the user's computing device, the synthetic audio response in synchronization with the video animation of the avatar.

2. The computer-implemented method of claim 1, wherein the natural language text transcript is generated by an artificial speech recognition engine.

3. The computer-implemented method of claim 1, wherein the vector similarity is determined using a vector cosine similarity function.

4. The computer-implemented method of claim 1, wherein the at least one text file includes one or more natural language text transcriptions of audio portions of at least one audio/visual video data generated by the target person.

5. The computer-implemented method of claim 4, wherein the audio/visual video data corresponds to the target person's life story.

6. The computer-implemented method of claim 4, wherein the audio/visual video data corresponds to the target person reading aloud one or more phrases presented to the target person.

7. The computer-implemented method of claim 4, wherein the at least one text file additionally includes one or more natural language text generated by the target person.

8. The computer-implemented method of claim 7, wherein the one or more natural language text corresponds to the target person's life story.

9. The computer-implemented method of claim 7, wherein the one or more first vector data structures are generated as a result of a word-embedding operation performed by the embedding engine on the at least one text file.

10. The computer-implemented method of claim 9, wherein the first artificial neural network is trained using the one or more first vector data structures.

11. The computer-implemented method of claim 4, wherein the second artificial neural network is trained using the audio portions of said at least one audio/visual video data along with the corresponding at least one text file.

12. The computer-implemented method of claim 4, wherein the third artificial neural network is trained using visual portions of the at least one audio/visual video data along with the corresponding audio portions of the at least one audio/visual video data.

13. A computer readable non-transitory medium comprising a plurality of executable programmatic instructions wherein, when said plurality of executable programmatic instructions are executed by a processor in a computing device, a process for generating an avatar representative of a target person is performed, wherein the avatar is configured to virtually embody audio, visual and behavioral characteristics of the target person and respond to a user's query based on the target person's life story, said plurality of executable programmatic instructions comprising:
programmatic instructions, stored in said computer readable non-transitory medium, for receiving first data indicative of the user's query, wherein the first data is in the form of an audio stream;
programmatic instructions, stored in said computer readable non-transitory medium, for transcribing the first data to generate a natural language text transcript corresponding to the first data;
programmatic instructions, stored in said computer readable non-transitory medium, for generating, by an embedding engine, a query vector data structure based on the natural language text transcript;
programmatic instructions, stored in said computer readable non-transitory medium, for generating, by a search engine, at least one text result based on a vector similarity of the query vector data structure with one or more first vector data structures associated with corresponding at least one text file stored in a database;
programmatic instructions, stored in said computer readable non-transitory medium, for providing as input, to a first artificial neural network, the at least one text result and the corresponding natural language text transcript in order to generate a text response;
programmatic instructions, stored in said computer readable non-transitory medium, for providing as input, to a second artificial neural network, the text response in order to generate a synthetic audio response;
programmatic instructions, stored in said computer readable non-transitory medium, for providing as input, to a third artificial neural network, the synthetic audio response in order to generate a video animation of the avatar, wherein the video animation corresponds to the avatar uttering the synthetic audio response; and
programmatic instructions, stored in said computer readable non-transitory medium, for rendering, on the user's computing device, the synthetic audio response in synchronization with the video animation of the avatar.

14. The computer readable non-transitory medium of claim 13, wherein the natural language text transcript is generated by an artificial speech recognition engine.

15. The computer readable non-transitory medium of claim 13, wherein the vector similarity is determined using a vector cosine similarity function.

16. The computer readable non-transitory medium of claim 13, wherein the at least one text file includes one or more natural language text transcriptions of audio portions of at least one audio/visual video data generated by the target person.

17. The computer readable non-transitory medium of claim 16, wherein the audio/visual video data corresponds to the target person's life story.

18. The computer readable non-transitory medium of claim 16, wherein the audio/visual video data corresponds to the target person reading out one or more phrases presented to the target person.

19. The computer readable non-transitory medium of claim 16, wherein the at least one text file additionally includes one or more natural language text generated by the target person.

20. The computer readable non-transitory medium of claim 19, wherein the one or more natural language text corresponds to the target person's life story.

21. The computer readable non-transitory medium of claim 19, wherein the one or more first vector data structures are generated as a result of a word-embedding operation performed by the embedding engine on the at least one text file.

22. The computer readable non-transitory medium of claim 21, wherein the first artificial neural network is trained using the one or more first vector data structures.

23. The computer readable non-transitory medium of claim 16, wherein the second artificial neural network is trained using the audio portions of said at least one audio/visual video data along with the corresponding at least one text file.

24. The computer readable non-transitory medium of claim 16, wherein the third artificial neural network is trained using visual portions of the at least one audio/visual video data along with the corresponding audio portions of the at least one audio/visual video data.

25. A computer-implemented method of generating an avatar representative of a target person, wherein the avatar is configured to virtually embody audio, visual and behavioral characteristics of the target person and respond to a user's query based on the target person's life story, the method comprising:
receiving first data indicative of the user's query, wherein the first data is in the form of an audio stream;
transcribing the first data to generate a natural language text transcript corresponding, wherein the transcription is performed manually;
generating, by an embedding engine, a query vector data structure based on the natural language text transcript;
generating, by a search engine, at least one text result based on a vector similarity of the query vector data structure with one or more first vector data structures associated with corresponding at least one text file stored in a database, wherein the at least one text file includes one or more natural language text transcriptions of audio portions of at least one audio/visual video data generated by the target person, and wherein the audio/visual video data corresponds to the target person's life story;
providing as input, to a first artificial neural network, the at least one text result and the corresponding natural language text transcript in order to generate a text response, wherein the first artificial neural network is trained using one or more first vector data structures, and wherein the one or more first vector data structures are generated as a result of a word-embedding operation performed by the embedding engine on the at least one text file;
providing as input, to a second artificial neural network, the text response in order to generate a synthetic audio response;
providing as input, to a third artificial neural network, the synthetic audio response in order to generate a video animation of the avatar, wherein the video animation corresponds to the avatar uttering the synthetic audio response; and
rendering, on the user's computing device, the synthetic audio response in synchronization with the video animation of the avatar.

26. The computer-implemented method of claim 25, wherein the vector similarity is determined using a vector cosine similarity function.

27. The computer-implemented method of claim 25, wherein the second artificial neural network is trained using the audio portions of said at least one audio/visual video data along with the corresponding at least one text file.

28. The computer-implemented method of claim 25, wherein the third artificial neural network is trained using visual portions of the at least one audio/visual video data along with the corresponding audio portions of the at least one audio/visual video data.
